(19) United States
(12) Patent Application Publication
(10) Pub. No.: US 2022/0272058 A1
(43) Pub. Date: Aug. 25, 2022

(54) System and Method for Electronic Messaging

(71) Applicant: Jonathan S. Woods, Duxbury, MA (US)

(72) Inventors: Jonathan S. Woods, Duxbury, MA (US); Byung Hyun Jang, Goyang City, Gyunggi-do (KR)

(21) Appl. No.: 17/631,312

(22) PCT Filed: Jul. 30, 2020
(86) PCT No.: PCT/US2020/044276

§ 371 Date: Jan. 28, 2022

Related U.S. Application Data
(60) Provisional application No. 62/882,327, filed on Aug. 2, 2019.

(51) Int. Cl. H04L 51/046; H04L 51/10; G06F 9/54; G06F 3/04883

(52) U.S. Cl. CPC H04L 51/046; H04L 51/10; G06F 9/547; G06F 3/04883

(57) ABSTRACT

A system and corresponding method for electronic messaging enable an author to add a plurality of user interface (UI) elements in an arrangement within a UI view, the arrangement defined by the author. Each UI element represents respective content and has respective metadata associated therewith for rendering the respective content within the UI view according to the arrangement at a later time. The UI view is generated, advantageously, within an environment supported by a messaging app, enabling the author to remain in a conversation of the messaging app. The system enables the plurality of UI elements, with the respective content and metadata associated therewith, to be uploaded to a server. The server generates a preview of the UI view that enables aspects of the UI view to be viewed on a recipient device without having to download the UI view to the recipient device.

### RELATED APPLICATION

This application claims the benefit of U.S. Provisional Application No. 62/882,327, filed on Aug. 2, 2019. The entire teachings of the above application are incorporated herein by reference.

### BACKGROUND

Messages may be communicated, electronically, using an electronic device. Text messaging is an example of a messaging modality that enables end users to communicate with each other, electronically, via electronic devices, such as mobile phones and other electronic devices. In addition to individual end users (e.g., teenagers and adults) being part of a population of “texters,” businesses have also joined the population, adopting “texting” as a means of communicating with customers.

### SUMMARY

According to an example embodiment, a method for electronic messaging enables an author to add a plurality of user interface (UI) elements in an arrangement within a UI view, wherein the arrangement is defined by the author. The UI view has associated therewith a UI view identifier. Each UI element represents respective content and has respective metadata associated therewith for rendering the respective content within the UI view according to the arrangement at a later time.

The example embodiment comprises generating a preview of the UI view, wherein the preview depicts the UI view having the plurality of UI elements in the arrangement defined by the author. The preview has the UI view identifier associated therewith. The example embodiment further comprises uploading the plurality of UI elements, with the respective content and metadata associated therewith, and the UI view identifier to a server. The uploading facilitates storage of the respective content and metadata of the plurality of UI elements, individually, in association with the UI view identifier. The example embodiment further comprises transmitting or enabling transmitting of the preview with the UI view identifier associated therewith to a recipient device. The recipient device may be configured to transmit, responsive to user interaction with the preview, a UI view request including the UI view identifier to the server. The example embodiment further comprises transmitting or enabling transmitting of the plurality of UI elements from the server to the recipient device, responsive to receipt by the server of the UI view request, by retrieving the plurality of UI elements, including the respective content and the respective metadata associated therewith, and forwarding same to the recipient device for rendering the respective content within a UI view on the recipient device according to the arrangement defined by the author. Transmitting or enabling transmitting of the plurality of UI elements may be referred to herein as transmitting or enabling transmitting of the UI view.

The UI view may be generated within an environment supported by a messaging app on a digital device. Enabling the author to add the plurality of UI elements and uploading the plurality of UI elements may be performed within the messaging app.

The UI view may also be generated within an environment supported by a native app on a digital device. Enabling the author to add the plurality of UI elements and uploading the plurality of UI elements may be performed within the interface, accessed via a native desktop app, a native mobile app, or through a web app accessed through a web browser. The author's work may synchronize across all devices and update in real time, on every device, when changes are made.

The messaging app may be an instant messaging app and may be loadable and executable by a handheld device.

Enabling the author to add the plurality of UI elements may include accessing a set of application program interfaces (APIs) of the messaging app.

The method may further comprise associating a conversation identifier with the UI view. Uploading the plurality of UI elements may further include uploading the conversation identifier to enable the rendering within a particular message conversation at the recipient device.

Uploading the plurality of UI elements may further facilitate associating the UI view identifier with at least one other UI view identifier associated with at least one other UI view. Transmitting or enabling transmission of the plurality of UI elements may include transmitting a respective plurality of UI elements, each respective plurality of UI elements associated with a respective UI view of a collection of UI views, the collection including the UI view and the at least one other view. The collection may include the UI view and the at least one other view.

The collection may be associated with a string. The string may include a title and description for the collection.

The method may further comprise enabling a user to: edit the UI view by adding an additional UI element to the plurality of UI elements, delete a given UI element from the plurality of elements, replace at least one UI element of the plurality of UI elements with another UI element, or a combination thereof.

The method may further comprise defining the arrangement as a function of at least one hand gesture performed by the author.

The method may further comprise, responsive to the at least one hand gesture, causing movement of at least one UI element of the plurality of UI elements, resizing the at least one UI element, or a combination thereof.

The preview may have a reduced resolution relative to a resolution of the UI view.

The respective content represented by at least one UI element of the plurality of UI elements may be interactive.

The respective content represented by the plurality of UI elements may include an image, video, text, text file, audio file, presentation software file, such as a Microsoft® PowerPoint® (PPT) file, spreadsheet file, such as a Microsoft® Excel® file, portable document file (PDF), graphics interchange format (GIF) file, uniform resource locator (URL), ZIP files, other digital file, voting buttons, lists, other interactive elements, or a combination thereof.

The UI view identifier may be associated with a user identifier associated with the author.

The method may further comprise associating at least one control parameter associated with the UI view. The at least one control parameter may include a permission parameter used to control forwarding, modification, or access to the UI view.

According to another example embodiment, an apparatus for electronic messaging comprises a display, memory, and a processor. The memory stores a sequence of instructions which, when loaded and executed by the processor, causes the processor to render a user interface (UI) view within an environment of a messaging app on the display. The sequence of instructions further causes the processor to enable an author to add a plurality of user interface (UI) elements in an arrangement within the UI view of the messaging app. The arrangement is defined by the author. The UI view has associated therewith a UI view identifier. Each UI element represents respective content and has respective metadata associated therewith for rendering the respective content within the UI view according to the arrangement at a later time. The sequence of instructions further causes the processor to upload the plurality of UI elements, with the respective content and metadata associated therewith, and the UI view identifier to a server. Uploading facilitates storage of the respective content and metadata of the plurality of UI elements, individually, in association with the UI view identifier. The sequence of instructions further causes the processor to transmit a UI view send request with the UI view identifier associated therewith to the server, causing the server to transmit the plurality of UI elements to a recipient device, responsive to receipt by the server of the UI view send request. The server is configured to transmit the plurality of UI elements by retrieving the plurality of UI elements, including the respective content and the respective metadata associated therewith, and forwarding same to the recipient device for rendering the respective content within a UI view on the recipient device according to the arrangement defined by the author. The server may be further configured to make a request in order to verify that the plurality of UI elements, their respective content and arrangement thereof, have been updated successfully on each device with which the user accesses the messaging app.

The sequence of instructions may further cause the processor to generate a preview of the UI view, the preview depicting the UI view having the plurality of UI elements in the arrangement defined by the author, the preview having the UI view identifier associated therewith. The sequence of instructions may further cause the processor to transmit the preview with the UI view identifier associated therewith to a recipient device.

In an event a change is made to the UI view by the author or a collaborator, the method may further comprise transmitting a UI view update to the recipient device, the UI view update causing the recipient device to render the respective content within a UI view on the recipient device according to the change, the change including a modification, addition, or deletion of at least one UI element of the plurality of elements.

Alternative apparatus embodiments parallel those described above in connection with the example method embodiment.

According to yet another example embodiment, a server for electronic messaging comprises a memory and processor. The memory stores a sequence of instructions which, when loaded and executed by the processor, causes the processor to store a plurality of user interface (UI) elements, with respective content and metadata associated therewith, for rendering the respective content within a UI view according to an arrangement defined by an author, in association with a UI view identifier of a UI view. The sequence of instructions further causes the processor to generate a preview of the UI view, the preview depicting the UI view having the plurality UI elements in the arrangement defined by the author. The preview has the UI view identifier associated therewith. The sequence of instructions further causes the processor to transmit the preview with the UI view identifier associated therewith to a recipient device. The recipient device is configured to transmit, responsive to user interaction with the preview, a UI view request with the UI view identifier associated therewith to the server. The sequence of instructions further causes the processor to transmit the plurality of UI elements to the recipient device, responsive to receipt of a UI view request, by retrieving the plurality of UI elements, including the respective content and the respective metadata associated therewith, and forwarding same to the recipient device for rendering the respective content within a UI view on the recipient device according to the arrangement defined by the author.

In an event a change is made to the UI view at the recipient device or at least one other electronic device communicatively coupled to the server, the sequence of instructions may further cause the processor to synchronize the UI view at the recipient device and at the at least one other electronic device, in real-time, by transmitting a UI view update, the UI view update including the change made.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a system for electronic messaging.

FIG. 1B is a block diagram of another example embodiment of a system for electronic messaging.

FIG. 2 is a block diagram of an example embodiment of an apparatus for electronic messaging.

FIG. 3 is a flow diagram of an example embodiment of a method for electronic messaging.

FIG. 4 is a block diagram of an example internal structure of a computer in which various embodiments of the present disclosure may be implemented.

### DETAILED DESCRIPTION

A description of example embodiments follows.

According to an example embodiment, an “emogo” may be communicated via a messaging app. The emogo (also referred to interchangeably herein as a “user interface (UI) view”) is defined herein as a collection or composition of media, such as photos, videos, files, notes, text, web links, graphics interchange format (GIF) files, etc. An example embodiment enables a user to create an emogo, enter information to be associated with the emogo, such as a title, description, etc., upload the emogo to a server, and share the emogo with other users. Permission with respect to access of the emogo may be set to be private or collaborative.

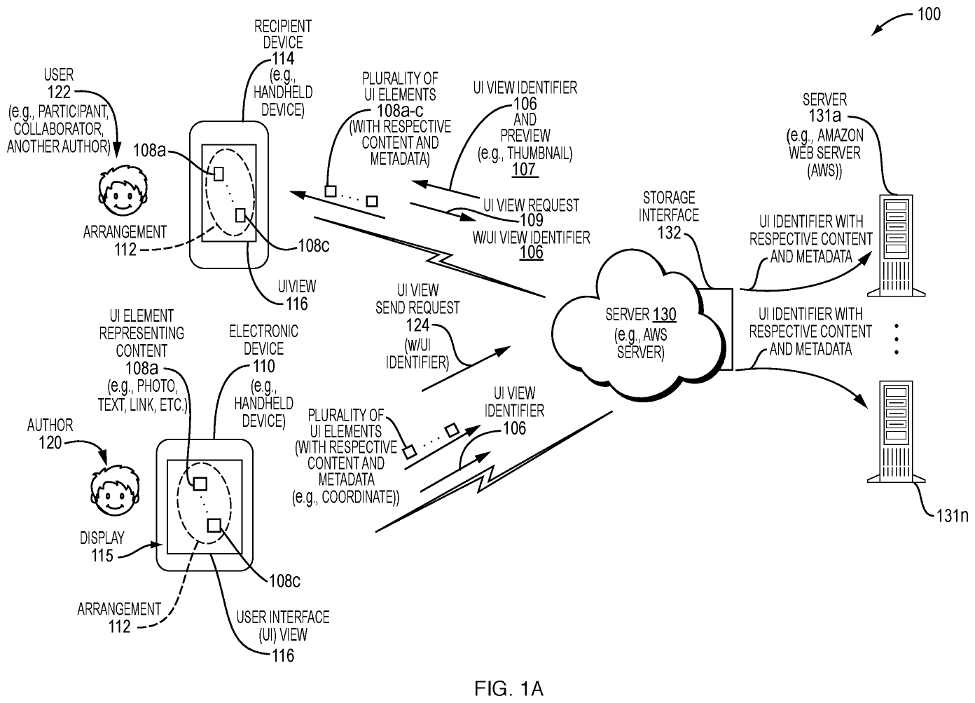

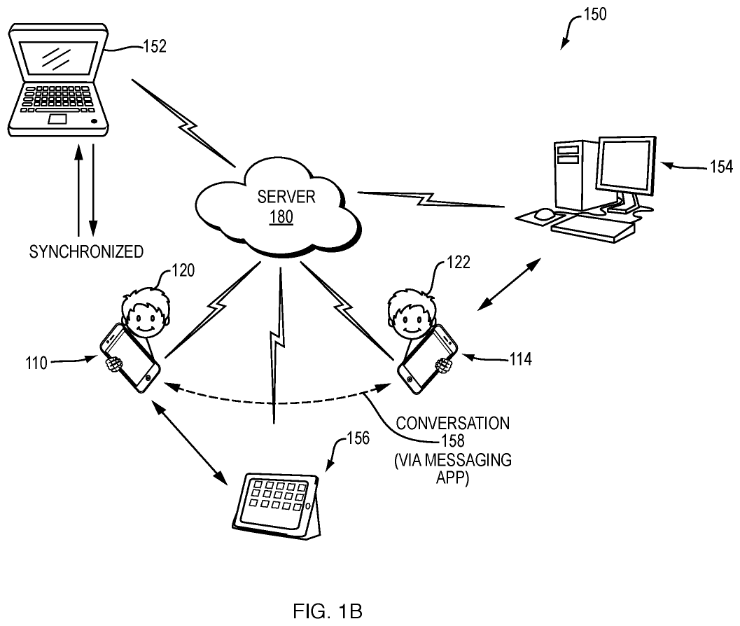

The emogo may be shared via an emogo app that is specialized for emogo creation, editing, and distribution, or may be shared via an instant messaging service. If shared via the emogo app, the emogo may be shared, directly. If shared via the instant messaging service, the emogo may be shared, indirectly, such as by sending a link to the emogo. According to an example embodiment, the creation of an emogo may be performed within the instant messaging service, directly. According to an example embodiment, the emogo may include a collection of user interface (UI) views, for example, a collection of “slides” of UI views, each with a plurality of UI elements that may be of any type of media. Such an emogo may be created by an end user, shared, and edited within a system, such as the system 100 of FIG. 1A, disclosed below.

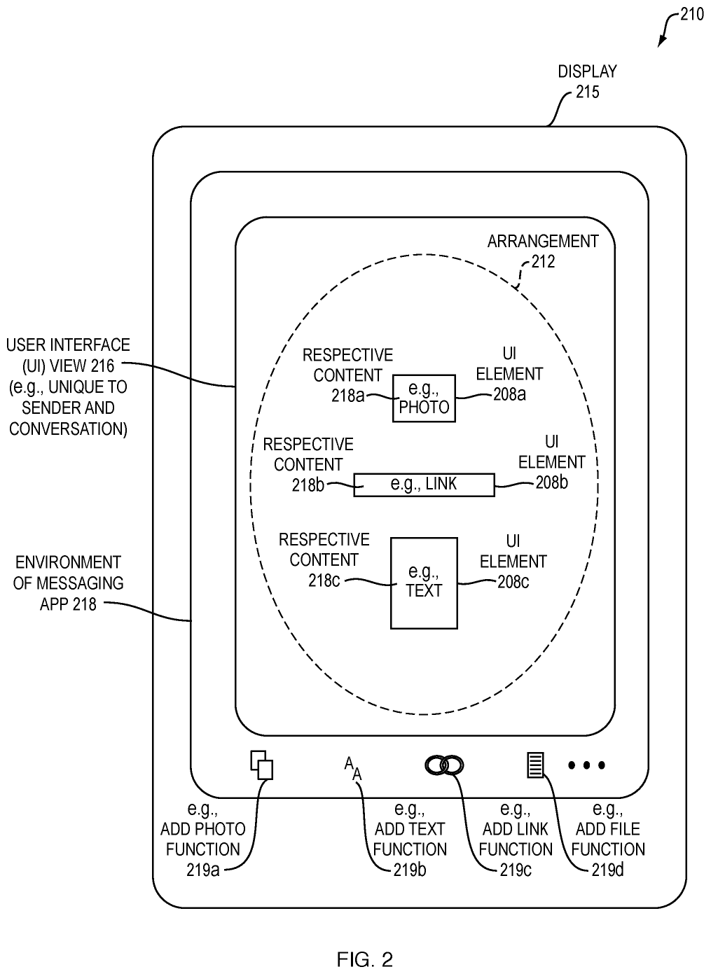

FIG. 1A is a block diagram of an example embodiment of a system 100 for electronic messaging. The system 100 includes a server 130. The server 130 may be an Amazon Web Services (AWS) server or other secure cloud services platform. The server 130 has a storage interface 132 to a plurality of other servers 131a-n that may include AWS servers or other cloud services platforms. In the system 100, an author 120 is using an electronic device 110, that may be a handheld device, such as a smartphone, or any other electronic device that comprises a display 115, memory (not shown), and processor (not shown), such as disclosed further below with regard to the apparatus 210 of FIG. 2. Continuing with reference to FIG. 1A, the author 120 may use the electronic device 110 to create an emogo, that is, a UI view 116 with an arrangement 112 of a plurality of UI elements 108a-c, and to share the emogo with a user 122 via the server 130 and a recipient device 114. The recipient device 114 may be a handheld device, such as a smartphone, or any other electronic device that comprises a display, memory, and processor, such the apparatus 210, disclosed further below with regard to FIG. 2.

The electronic device 110 may be configured to render a UI view 116 within an environment (not shown) of a messaging app (not shown) on the display 115. The electronic device 110 may be further configured to associate at least one control parameter (not shown) with the UI view 116. The at least one control parameter may include a permission parameter used to control forwarding, modification, or access to the UI view 116. The UI view 116 may be associated with metadata (not shown) that may include, for example, a title defined by the author 120, a user identifier (not shown) of the author 120, and privacy information (not shown) regarding the UI view 116 as defined by the author 120.

The UI view 116 may also be generated within an environment (not shown) supported by a native app on the electronic device 110. Enabling the author to add the plurality of UI elements and uploading the plurality of UI elements 108a-c may be performed within an interface, accessed via a native desktop app, a native mobile app, or through a web app accessed through a web browser. The author's work may synchronize across all devices and update in real time, on every device, when changes are made.

The UI view 116 may be referred to interchangeably herein as a “canvas.” The electronic device 110 may enable the author 120 to add a plurality of UI elements 108a-c in an arrangement 112 within the UI view 116 of the messaging app. The arrangement 112 is defined by the author 120. The electronic device 110 may enable the author 120 to define the arrangement 112 as a function of at least one hand gesture performed by the author 120. Responsive to the at least one hand gesture, the electronic device 110 may move at least one UI element of the plurality of UI elements 108a-c, resize the at least one UI element, or a combination thereof.

The UI view 116 has associated therewith a UI view identifier 106. The UI view identifier 106 may be associated with the user identifier that is associated with the author 120. Each UI element represents respective content (not shown) and has respective metadata (not shown) associated therewith for rendering the respective content within the UI view 116 according to the arrangement 112 at a later time. The respective content may be interactive and may include an image, video, text, text file, audio file, presentation software file, such as a Microsoft® PowerPoint® (PPT) file, spreadsheet file, such as a Microsoft® Excel® file, portable document file (PDF), graphics interchange format (GIF) file, uniform resource locator (URL), ZIP files, other digital file, voting buttons, lists, other interactive elements, or a combination thereof.

The electronic device 110 is configured to upload the plurality of UI elements 108a-c, with the respective content and metadata associated therewith, and the UI view identifier 106 to the server 130. Such uploading facilitates storage of the respective content and metadata of the plurality of UI elements 108a-c, individually, in association with the UI view identifier 106, also referred to interchangeably herein as an emogo identifier (ID), and a user identifier of the author 120, at a single server or at a plurality of servers of the servers 13 la-n.

The respective content and metadata of the plurality of UI elements 108a-c may be stored individually, on a per-UI element basis, in association with the UI view identifier 106. Such storage advantageously enables individual access to each UI element of the plurality of UI elements 108a-c of the composite UI view 116 for editing. According to an example embodiment, the server 130 may be configured to maintain a creation time for the UI view 116, title, description, and cover for the UI view 116, revision history for the UI view 116, on a per UI-view or per-UI-element-per-UI-view basis, or a combination thereof. Uploading of the plurality of UI elements 108a-c may be performed, advantageously, within the messaging app, enabling the author 120 to remain within a conversation of the messaging app.

The electronic device 110 may be further configured to transmit a UI view send request 124 with the UI view identifier 106 associated therewith to the server 130, causing the server 130 to transmit the plurality of UI elements 108a-c to the recipient device 114, responsive to receipt by the server 130 of the UI view send request 124. The server 130 may transmit the plurality of UI elements 108a-c by retrieving the plurality of UI elements 108a-c, including the respective content 118a-c and the respective metadata associated therewith, and forwarding same to the recipient device 114 for rendering the respective content within a UI view 116 on the recipient device 114 according to the arrangement 112 defined by the author 120. The electronic device 110 may associate a conversation identifier (not shown) with the UI view 116. The uploading may include uploading the conversation identifier to enable the rendering within a particular message conversation at the recipient device 114.

The uploading may further facilitate associating the UI view identifier 106 with at least one other UI view identifier (not shown) associated with at least one other UI view. Transmitting or enabling transmission of the plurality of UI elements 108a-c may further include transmitting a respective plurality of UI elements, each respective plurality of UI elements associated with a respective UI view of a collection of UI views. The collection may include the UI view 116 and the at least one other view.

The server 130 may generate a preview 107 (e.g., thumbnail) of the UI view 116. The preview 107 depicts the UI view 116 having the plurality of UI elements 108a-c in the arrangement 112 defined by the author 120. The preview 107 has the UI view identifier 106 associated therewith. The server 130 transmits the preview 107 with the UI view identifier associated therewith 106 to the recipient device 114 for display to the user 122. The preview 107 may have a reduced resolution relative to a resolution of the UI view 116. The preview 107 enables the user 122 to “see” UI views stored at the server 130 without downloading such UI views to the recipient device 114. If the user 122 chooses to have the UI view 116 downloaded to the recipient device 122, an example embodiment enables such a download in response to user interaction of the user 122 with the preview 107.

For example, responsive to user interaction with the preview 107, the recipient device 114 may be configured to transmit a UI view request 109 with the UI view identifier 106 associated therewith to the server 130. The server 130 may be configured to transmit the plurality of UI elements 108a-c to the recipient device 114, responsive to receipt of a UI view request 109, by retrieving the plurality of UI elements 108a-c, including the respective content and the respective metadata associated therewith, and forwarding same to the recipient device 114 for rendering the respective content within the UI view 116 according to the arrangement 112 defined by the author 120. The server 130 may be further configured to make a request in order to verify that the plurality of UI elements 108a-c, their respective content and arrangement 112, have been updated successfully on each device with which the user accesses the messaging app.

The recipient device 114 may enable the user 112 to edit the UI view 116 by adding an additional UI element (not shown) to the plurality of UI elements 108a-c, delete a given UI element from the plurality of elements 108a-c, replace at least one UI element of the plurality of UI elements 108a-c with another UI element, or a combination thereof. As such, the user 122 may collaborate on the content of the UI view 116 and upload such edits to the server 130 to modify the UI view 116 maintained at the server 130. Because the plurality of UI elements 108a-c are stored and individually accessible at the server 130, the UI view 116 may be modified without having to upload the entire UI view 116 back to the server 130, disclosed in further detail below with regard to FIG. 1B.

FIG. 1B is a block diagram of another example embodiment of a system 150 for electronic messaging. The system 150 includes the server 130, disclosed above with regard to FIG. 1A. The server 130 is communicatively coupled to a plurality of electronic devices, namely, the computer desktop/laptop 152, computer desktop 154, first mobile device, referred to as the electronic device 110, second mobile device, referred to as the recipient device 114, and third mobile device 156.

In the example embodiment of FIG. 1B, the first and second mobile devices are smartphones, and the third mobile device is a tablet. It should be understood, however, that the number of electronic devices communicatively coupled to the server 130 is not limited to the number of electronic devices of FIG. 1B, and the types of electronic devices communicatively coupled to the server 130 are not limited to the types of electronic devices of FIG. 1B.

According to an example embodiment, the desktop/laptop 152 may employ a Macintosh (Mac) operating system (OS) developed by Apple, Inc., the first and second mobile devices, that is, the electronic device 110 and recipient device 114, may employ an iOS, that is, a mobile OS developed by Apple, Inc., and the third mobile device 156 may employ an iPadOS developed by Apple, Inc. It should be understood, however, that an OS employed by an electronic device disclosed herein is not limited to being developed by Apple, Inc.

As disclosed above, the “emogo” may be communicated via the messaging app. In the example embodiment, two users, namely the author 120 and the recipient 122, are having a conversation 158 via the messaging app and such conversation may include the emogo. The author 120 has created the emogo. As disclosed above, content (not shown) of the emogo may be interactive and may include an image, video, text, text file, audio file, presentation software file, such as a Microsoft® PowerPoint® (PPT) file, spreadsheet file, such as a Microsoft® Excel® file, portable document file (PDF), graphics interchange format (GIF) file, uniform resource locator (URL), ZIP files, other digital file, voting buttons, lists, other interactive elements, or a combination thereof. Such content may be organized into folders (not shown).

The emogo may have been created by the author 120 using any type of electronic device. For example, the author 120 may have used a mobile app of the iOS of a smartphone. Alternatively, the user may have used a desktop app of a MacOS running on a desktop computer. Alternatively, the author may have created the emogo from within the messaging app, directly, which may be employed on a mobile or desktop device. According to an example embodiment, updates to the emogo are synchronized in real-time to the electronic devices in real-time.

For example, the author 120 may create the emogo inside the messaging app and transmit the emogo to the recipient 122. The author 120 may then add additional media to the emogo from a desktop, such as the desktop/laptop 152. When the recipient 122 views the emogo (from any device), such as the recipient device 114, desktop 154, or tablet 156, the recipient 122 is able to view the new content because the server 130 has synchronized, in real-time, the updates to the emogo to the electronic devices communicatively coupled to the server 130. This will work the same if the recipient 122 is a collaborator on the emogo created by the author 120. For example, any change or update to the emogo that is made by the recipient is synchronized in real-time by the server 130 across the electronic devices communicatively coupled to the server 130.

As such, a user, such as the author 120, may employ any type of electronic device to create, upload, organize, edit, generate a link to, and control privacy of an emogo. The author 120 may use that same device or a different device to send the emogo to others, such as the recipient 122. Any changes made to the emogo by the author 120 of the emogo, or by a collaborator, are synchronized, in real-time, by the server 130 to the electronic devices communicatively coupled to the server 130. Such electronic devices may be any type of electronic device that comprises a display, memory, and processor, such the apparatus 210, disclosed below with regard to FIG. 2.

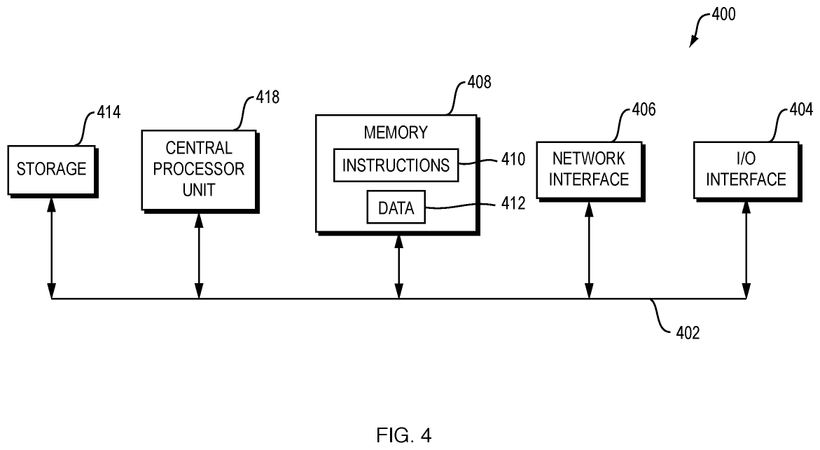

FIG. 2 is a block diagram of an example embodiment of an apparatus 210 for electronic messaging. The apparatus 210 comprises a display 215. The apparatus 210 further comprises memory (not shown) and a processor (not shown), such as the memory 408 and processor 418, disclosed further below with regard to FIG. 4. Continuing to refer to FIG. 2, the apparatus 210 may be a handheld device, such as a smartphone or other handheld electronic device; however, it should be understood that the apparatus 210 is not limited to a handheld device and may be any electronic device that comprises the display 215, memory, and processor.

The memory stores a sequence of instructions, such as the instructions 410 disclosed further below with regard to FIG. 4. The instructions, when loaded and executed by the processor, cause the processor to render a user interface (UI) view 216 within an environment 218 of a messaging app on the display 215. The sequence of instructions may further cause the processor to enable an author (not shown), such as the author 120 of FIG. 1A, disclosed above, to add a plurality of user interface (UI) elements 208a-c in an arrangement 212 within the UI view 216 of the messaging app. The arrangement 212 is defined by the author.

The environment 218 of the messaging app may include media functions, such as the media functions 219a-d that may be used to add a photo, text, link, or file, respectively, to the UI view 216. It should be understood that the media functions 219a-d are not limited to adding a photo, text, link, or file.

The UI view 216 may have associated therewith a UI view identifier (not shown). Each UI element represents respective content 218a-c and has respective metadata (not shown) associated therewith for rendering the respective content 218a-c within the UI view 216 according to the arrangement 212 at a later time. Such metadata may be associated with a respective UI element, automatically, as a function of placement, content, sizing, or a combination thereof, of the corresponding respective content. The respective content 218a-c may be interactive and may include an image, video, text, text file, audio file, presentation software file, such as a Microsoft® PowerPoint® (PPT) file, spreadsheet file, such as a Microsoft® Excel® file, portable document file (PDF), graphics interchange format (GIF) file, uniform resource locator (URL), ZIP files, other digital file, voting buttons, lists, other interactive elements, or a combination thereof.

The sequence of instructions further causes the processor to upload the plurality of UI elements 208a-c, with the respective content and metadata associated therewith, and the UI view identifier to a server (not shown), such as the server 130 of FIG. 1A, disclosed above. Uploading may facilitate storage of the respective content 218a-c and metadata of the plurality of UI elements 208a-c, individually, in association with the UI view identifier. The sequence of instructions further causes the processor to transmit a UI view send request (not shown) with the UI view identifier associated therewith to the server, causing the server to transmit the plurality of UI elements 208a-c to a recipient device (not shown), responsive to receipt by the server of the UI view send request, such as disclosed above with regard to FIG. 1A. The server may transmit the plurality of UI elements 208a-c by retrieving the plurality of UI elements 208a-c, including the respective content 218a-c and the respective metadata associated therewith, and forward same to the recipient device for rendering the respective content 218a-c within the UI view 216 according to the arrangement 212 defined by the author.

The sequence of instructions further causes the processor to generate a preview (not shown) of the UI view 216, the preview depicting the UI view 216 having the plurality of UI elements 208a-c in the arrangement 212 defined by the author, the preview having the UI view identifier associated therewith. The sequence of instructions further causes the processor to transmit the preview with the UI view identifier associated therewith to a recipient device, such as disclosed above with regard to FIG. 1A.

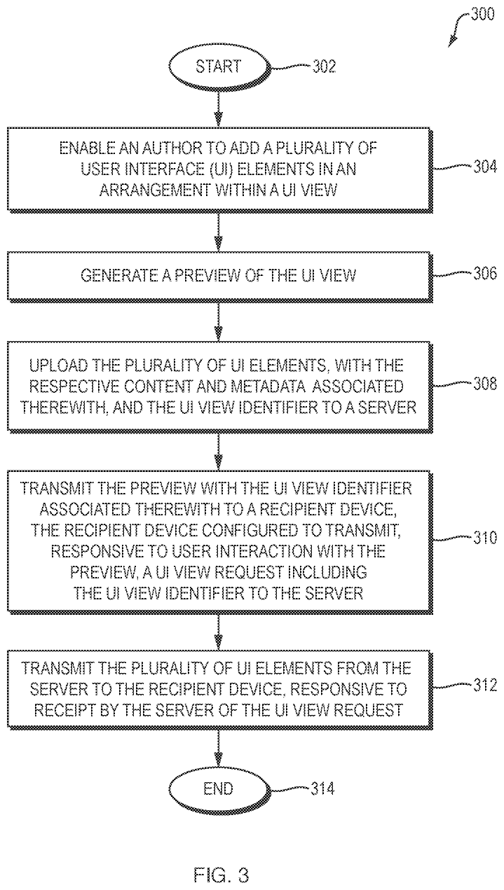

FIG. 3 is a flow diagram 300 of an example embodiment of a method for electronic messaging. The method begins (302) and enables an author to add a plurality of user interface (UI) elements in an arrangement within a UI view (304). The arrangement is defined by the author. The UI view has associated therewith a UI view identifier. Each UI element represents respective content and has respective metadata associated therewith for rendering the respective content within the UI view according to the arrangement at a later time. The method generates a preview of the UI view (306). The preview depicts the UI view having the plurality of UI elements in the arrangement defined by the author. The preview may have the UI view identifier associated therewith. The UI view identifier may be associated with a user identifier associated with the author.

The method uploads the plurality of UI elements, with the respective content and metadata associated therewith, and the UI view identifier to a server (308). The uploading facilitates storage of the respective content and metadata of the plurality of UI elements, individually, in association with the UI view identifier. The method transmits or enables transmission of the preview with the UI view identifier associated therewith to a recipient device, the recipient device configured to transmit, responsive to user interaction with the preview, a UI view request including the UI view identifier to the server (310). The preview may have a reduced resolution relative to a resolution of the UI view.

According to an example embodiment, the method may enable transmission of the preview by sending a request to send the preview in combination with a representation of at least one recipient. According to one embodiment, the at least one recipient may be a plurality of recipients and the representation may be an identifier of a contact list including identifiers of the plurality of recipient. Such an embodiment provides a savings in bandwidth relative to sending individual requests to send the preview to each recipient on a recipient-by-recipient basis.

The method transmits or enables transmission of the plurality of UI elements from the server to the recipient device, responsive to receipt by the server of the UI view request, by retrieving the plurality of UI elements, including the respective content and the respective metadata associated therewith, and forwards same to the recipient device for rendering the respective content within a UI view on the recipient device according to the arrangement defined by the author (312), and the method thereafter ends (314) in the example embodiment.

According to an example embodiment, the method may enable transmission of the plurality of UI elements by sending a request to send the plurality of UI elements in combination with a representation of at least one recipient. According to one embodiment, the at least one recipient may be a plurality of recipients and the representation may be an identifier of a contact list including identifiers of the plurality of recipient. Such an embodiment provides a savings in bandwidth relative to sending individual requests to send the plurality of UI elements to each recipient on a recipient-by-recipient basis.

The UI view may be generated within an environment supported by a messaging app on a digital device, such as disclosed with regard to FIG. 2, above. The enabling and uploading may be enabled to be performed within the messaging app. The messaging app may be an instant messaging app. The instant messaging app may be loadable and executable by a handheld device. The enabling may include accessing a set of application program interfaces (APIs) of the messaging app.

The UI view may also be generated within an environment supported by a native app on a digital device. Enabling the author to add the plurality of UI elements and uploading the plurality of UI elements may be performed within the interface, accessed via a native desktop app, a native mobile app, or through a web app accessed through a web browser. The author's work may synchronize across all devices and update in real time, on every device, when changes are made.

The method may further comprise associating a conversation identifier with the UI view. The uploading may further include uploading the conversation identifier to enable the rendering within a particular message conversation at the recipient device.

The uploading may further facilitate associating the UI view identifier with at least one other UI view identifier associated with at least one other UI view. Transmitting the plurality of UI elements may further include transmitting a respective plurality of UI elements, each respective plurality of UI elements associated with a respective UI view of a collection of UI views. The collection may include the UI view and the at least one other view. The collection may be associated with a string. The string may include a title and description for the collection.

The method may further comprise enabling a user to: edit the UI view by adding an additional UI element to the plurality of UI elements, delete a given UI element from the plurality of elements, replace at least one UI element of the plurality of UI elements with another UI element, or a combination thereof.

The method may further comprise defining the arrangement as a function of at least one hand gesture performed by the author. The method may further comprise, responsive to the at least one hand gesture, causing movement of at least one UI element of the plurality of UI elements, resizing the at least one UI element, or a combination thereof.

The respective content represented by at least one UI element of the plurality of UI elements may be interactive. The respective content represented by the plurality of UI elements may include an image, video, text, text file, audio file, presentation software file, such as a Microsoft® PowerPoint® (PPT) file, spreadsheet file, such as a Microsoft® Excel® file, portable document file (PDF), graphics interchange format (GIF) file, uniform resource locator (URL), ZIP files, other digital file, voting buttons, lists, other interactive elements, or a combination thereof.

The method may further comprise associating at least one control parameter associated with the UI view. The at least one control parameter may include a permission parameter used to control forwarding, modification, or access to the UI view.

FIG. 4 is a block diagram of an example of the internal structure of a computer 400 in which various embodiments of the present disclosure may be implemented. The computer 400 contains a system bus 402, where a bus is a set of hardware lines used for data transfer among the components of a computer or processing system. The system bus 402 is essentially a shared conduit that connects different elements of a computer system (e.g., processor, disk storage, memory, input/output ports, network ports, etc.) that enables the transfer of information between the elements. Coupled to the system bus 402 is an I/O device interface 404 for connecting various input and output devices (e.g., keyboard, mouse, displays, printers, speakers, etc.) to the computer 400. According to one embodiment, the I/O device interface 404 may connect to a display of handheld device for displaying a UI view, such as the UI view 216 of FIG. 2, disclosed above. A network interface 406 allows the computer 400 to connect to various other devices attached to a network, such as the server 130, electronic device 110, or recipient device 114 of FIG. 1A, disclosed above.

Memory 408 provides volatile storage for computer software instructions 410 and data 412 that may be used to implement embodiments of the present disclosure. Disk storage 414 provides non-volatile storage for computer software instructions 410 and data 412 that may be used to implement embodiments of the present disclosure. For example, a central processor unit 418 is also coupled to the system bus 402 and provides for the execution of computer instructions. The computer software instructions 410, when loaded and executed by the central processor unit 418, may cause the central processor unit 418 to render the UI view 216 of FIG. 2, disclosed above. The computer software instructions 410 may further cause the central processor unit 418 to enable an author, such as the author 120 of FIG. 1A, disclosed above, to add a plurality of UI elements in an arrangement within the UI view, such as the plurality of UI elements 208a-c in the arrangement 212 within the UI view 216 of FIG. 2, disclosed above.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 4, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein. Further, example embodiments and elements thereof may be combined in a manner not explicitly disclosed herein.

While example embodiments have been particularly shown and described, it will be understood by those skilled in the art that various changes in form and details may be made therein without departing from the scope of the embodiments encompassed by the appended claims.

What is claimed is:

1. A method for electronic messaging, the method comprising:
enabling an author to add a plurality of user interface (UI) elements in an arrangement within a UI view, the arrangement defined by the author, the UI view having associated therewith a UI view identifier, each UI element representing respective content and having respective metadata associated therewith for rendering the respective content within the UI view according to the arrangement at a later time;
generating a preview of the UI view, the preview depicting the UI view having the plurality of UI elements in the arrangement defined by the author, the preview having the UI view identifier associated therewith;
uploading the plurality of UI elements, with the respective content and metadata associated therewith, and the UI view identifier to a server, the uploading facilitating storage of the respective content and metadata of the plurality of UI elements, individually, in association with the UI view identifier;
transmitting or enabling transmitting of the preview with the UI view identifier associated therewith to a recipient device, the recipient device configured to transmit, responsive to user interaction with the preview, a UI view request including the UI view identifier to the server; and
transmitting or enabling transmitting of the plurality of UI elements from the server to the recipient device, responsive to receipt by the server of the UI view request, by retrieving the plurality of UI elements, including the respective content and the respective metadata associated therewith, and forwarding same to the recipient device for rendering the respective content within a UI view on the recipient device according to the arrangement defined by the author.

2. The method of claim 1, wherein the UI view is generated within an environment supported by a messaging app on a digital device and wherein the enabling and uploading are enabled to be performed within the messaging app.

3. The method of claim 2, wherein the messaging app is an instant messaging app.

4. The method of claim 3, wherein the instant messaging app is loadable and executable by a handheld device.

5. The method of claim 2, wherein the enabling includes accessing a set of application program interfaces (APIs) of the messaging app.

6. The method of claim 1, further comprising associating a conversation identifier with the UI view and wherein the uploading further includes uploading the conversation identifier to enable the rendering within a particular message conversation at the recipient device.

7. The method of claim 1, wherein the uploading further facilitates associating the UI view identifier with at least one other UI view identifier associated with at least one other UI view, and wherein transmitting or enabling transmission of the plurality of UI elements includes transmitting a respective plurality of UI elements, each respective plurality of UI elements associated with a respective UI view of a collection of UI views, the collection including the UI view and the at least one other view.

8. The method of claim 7, wherein the collection is associated with a string, the string including a title and description for the collection.

9. The method of claim 1, further comprising enabling a user to: edit the UI view by adding an additional UI element to the plurality of UI elements, delete a given UI element from the plurality of elements, replace at least one UI element of the plurality of UI elements with another UI element, or a combination thereof.

10. The method of claim 1, further comprising defining the arrangement as a function of at least one hand gesture performed by the author.

11. The method of claim 10, further comprising, responsive to the at least one hand gesture, causing movement of at least one UI element of the plurality of UI elements, resizing the at least one UI element, or a combination thereof.

12. The method of claim 1, wherein the preview has a reduced resolution relative to a resolution of the UI view.

13. The method of claim 1, wherein the respective content represented by at least one UI element of the plurality of UI elements is interactive.

14. The method of claim 1, wherein the respective content represented by the plurality of UI elements includes an image, video, text, text file, audio file, presentation software file, spreadsheet file, portable document file (PDF), graphics interchange format (GIF) file, uniform resource locator (URL), ZIP files, other digital file, voting buttons, lists, other interactive elements, or a combination thereof.

15. The method of claim 1, wherein the UI view identifier is associated with a user identifier associated with the author.

16. The method of claim 1, further comprising associating at least one control parameter associated with the UI view, the at least one control parameter including a permission parameter used to control forwarding, modification, or access to the UI view.

17. The method of claim 1, wherein, in an event a change is made to the UI view by the author or a collaborator, the method further comprises transmitting a UI view update to the recipient device, the UI view update causing the recipient device to render the respective content within a UI view on the recipient device according to the change, the change including a modification, addition, or deletion of at least one UI element of the plurality of elements.

18. An apparatus for electronic messaging, the apparatus comprising:
a display;
a memory; and
a processor, the memory storing a sequence of instructions which, when loaded and executed by the processor, causes the processor to:
render a user interface (UI) view within an environment of a messaging app on the display;
enable an author to add a plurality of user interface (UI) elements in an arrangement within the UI view of the messaging app, the arrangement defined by the author, the UI view having associated therewith a UI view identifier, each UI element representing respective content and having respective metadata associated therewith for rendering the respective content within the UI view according to the arrangement at a later time; and
upload the plurality of UI elements, with the respective content and metadata associated therewith, and the UI view identifier to a server, the uploading facilitating storage of the respective content and metadata of the plurality of UI elements, individually, in association with the UI view identifier; and
transmit a UI view send request with the UI view identifier associated therewith to the server, causing the server to transmit the plurality of UI elements to a recipient device, responsive to receipt by the server of the UI view send request, by retrieving the plurality of UI elements, including the respective content and the respective metadata associated therewith, and forwarding same to the recipient device for rendering the respective content within a UI view on the recipient device according to the arrangement defined by the author.

19. The apparatus of claim 18, wherein the sequence of instructions further causes the processor to:
generate a preview of the UI view, the preview depicting the UI view having the plurality of UI elements in the arrangement defined by the author, the preview having the UI view identifier associated therewith; and
transmit the preview with the UI view identifier associated therewith to a recipient device.

20. The apparatus of claim 18, wherein the sequence of instructions further causes the processor to update the UI view within the environment of the messaging app on the display based on a UI view update received from the server, the UI view update triggered by a change made to the UI view at the recipient device.

21. A server for electronic messaging, the server comprising:
a memory; and
a processor, the memory storing a sequence of instructions which, when loaded and executed by the processor, causes the processor to:
store a plurality of user interface (UI) elements, with respective content and metadata associated therewith, for rendering the respective content within a UI view according to an arrangement defined by an author, in association with a UI view identifier of a UI view;
generate a preview of the UI view, the preview depicting the UI view having the plurality UI elements in the arrangement defined by the author, the preview having the UI view identifier associated therewith;
transmit the preview with the UI view identifier associated therewith to a recipient device, the recipient device configured to transmit, responsive to user interaction with the preview, a UI view request with the UI view identifier associated therewith to the server; and
transmit the plurality of UI elements to the recipient device, responsive to receipt of a UI view request, by retrieving the plurality of UI elements, including the respective content and the respective metadata associated therewith, and forwarding same to the recipient device for rendering the respective content within a UI view on the recipient device according to the arrangement defined by the author.

22. The server of claim 21, wherein, in an event a change is made to the UI view at the recipient device or at least one other electronic device communicatively coupled to the server, the sequence of instructions further causes the processor to synchronize the UI view at the recipient device and at the at least one other electronic device, in real-time, by transmitting a UI view update, the UI view update including the change made.
